(19) United States
(12) Patent Application Publication
(10) Pub. No.: US 2004/0035625 A1
(43) Pub. Date: Feb. 26, 2004

(54) Ergonomic arrangement for a three-wheeled vehicle

(76) Inventors: Jean-Guy Talbot, Valcourt (CA); Pierre Savoie, Montreal (CA); Martin Aube, St-Bruno-de-Montarville (CA); Alain Massicotte, Orford (CA); Bruno Girouard, Montreal (CA); Berthold Fecteau, Richmond (CA)

Correspondence Address: PILLSBURY WINTHROP, LLP, P.O. BOX 10500, MCLEAN, VA, 22102, US

(21) Appl. No.: 10/371,232

(22) Filed: Feb. 24, 2003

Related U.S. Application Data
(60) Provisional application No. 60/358,400, filed on Feb. 22, 2002.
(60) Provisional application No. 60/358,395, filed on Feb. 22, 2002.

(51) Int. Cl. B62K 5/02

(52) U.S. Cl. 180/210

(57) ABSTRACT

A three-wheeled vehicle is designed for road use. The three-wheeled vehicle has an internal combustion engine that drives a single rear wheel and a pair of steerable front wheels. The vehicle is designed with optimal ranges for ergonomic comfort.

This application relies for priority on U.S. Provisional Patent Application No. 60/358,400 and No. 60/358,395, both filed Feb. 22, 2002 and hereby incorporates herein the subject matter of these applications by reference.

This application is also related but does not claim priority to the following U.S. provisional applications that were filed on Feb. 22, 2002: No. 60/358,362; No. 60/358,394; No. 60/358,390; No. 60/358,436; No. 60/358,397; No. 60/358,439; and, No. 60/358,398 and any non-provisional patent applications claiming priority to the same. This application is also related but does not claim priority to U.S. provisional application No. 60/358,737 filed on Feb. 25, 2002, and U.S. provisional application No. 60/418,355, which was filed on Oct. 16, 2002 and any non-provisional patent applications claiming priority to the same. The entirety of the subject matter of these applications is incorporated by reference herein.

This application is also related to but does not claim priority to U.S. Design application Ser. No. 29/155,964 filed on Feb. 22, 2002, and U.S. Design application Ser. No. 29/156,028 filed on Feb. 23, 2002. This application is also related to but does not claim priority to U.S. patent application Ser. No. 10/346,188 and U.S. patent application Ser. No. 10/346,189 which were filed on Jan. 17, 2003. The entirety of the subject matter of these applications is incorporated by reference herein.

### BACKGROUND OF THE INVENTION

1. Field of the Invention

This invention relates to vehicles, particularly vehicles designed for road use. Specifically, this invention is directed to three-wheeled vehicles driven by a power unit and designed for stability and rider comfort.

2. Background of the Invention

The prior art includes several examples of three-wheeled vehicles, some of which have been engineered for road use.

One type of three-wheeled vehicle known in the prior art is the three-wheeled All Terrain Vehicle (“ATV”), which was popularized in the early to mid 1980s. That ATV included two rear wheels powered by an internal combustion engine and a single front wheel steered by a standard handlebar arrangement. While popular, this ATV suffered from an instability problem for two reasons. First, the ATV relied on large balloon tires for its operation, which raised the center of gravity of the vehicle an appreciable distance above the ground. Second, the because the ATV included a single tire at the front, during turning at a sufficiently-high speed, the rear tires had a tendency to lift off the ground. At certain speeds, therefore, the vehicle could overturn.

One way that designers of three-wheeled ATVs dealt with the instability of the vehicle was to install low-output engines into the vehicles. Since the vehicle was limited in its output power, the probability of an overturn incident was lower. Being designed for off-road use, the lower engine output was not a detrimental feature because the vehicle was not designed to operate at road speeds or even at velocities approaching road speeds.

Another three-wheeled vehicle known to exist in the prior art is the three-wheeled motorcycle. The three-wheeled motorcycle typically is a standard motorcycle where the rear wheel has been removed and replaced with an axle having a wheel at either end. As with the three-wheeled ATV, however, the three-wheeled motorcycle suffers from an instability problem, especially at higher speeds.

A third type of three-wheeled vehicle known in the art is the motorcycle with a side car capable of accommodating a single passenger. In this example, the tire supporting the side car typically is off-set from the rear tire on the motorcycle. As might be expected, this vehicle also suffers from an instability problem.

The second and third types of three-wheeled vehicles described above differ from the ATV example in that they are designed for road use. In addition, these types of three-wheeled vehicles typically include engines that can generate an output power greater than that capable of being generated by the prior art three-wheeled ATV. In the typical case, the engine of the three-wheeled ATV generated about 35 horsepower. The engines of the motorcycles adapted with three wheels typically generate a greater output power.

A fourth type of three-wheeled vehicle that has made a commercial appearance is a vehicle with two front wheels and a single rear wheel. Typically, such vehicles have been styled like cars and, as a result, the operator sits within a bucket-type seat within the frame rather than straddling the frame as in the ATV or motorcycle examples.

Recently, a fifth example of a three-wheeled vehicle became known in the prior art. This fifth example started from a motorcycle, in particular the Yamaha® V-max. The designed removed the front tire and replaced the front tire with a front suspension capable of supporting two front tires. The handle bars on the motorcycle frame remained the steering device for the vehicle. In addition, the designer kept the motorcycle wheel at the rear of the frame.

In addition, U.S. Pat. No. 4,787,470 discloses a three-wheeled vehicle for a single rider with two front wheels and one rear wheel that is designed for off-road use. Issues with stability are addressed in this prior art vehicle by several design characteristics. First, the front tires are large, low-pressure balloon tires, which have a relatively large contact patch with the ground. The rear tire is also a low-pressure balloon tire and has a substantially greater contact patch with the ground than the front tires. To improve stability and handling, the contact patch of the rear tire equals the sum of the contact patches of the front tires. Second, the power plant is a motorcycle engine mounted within the frame with its cylinder block disposed at an angle to the vertical and closely positioned to the horizontal. Third, the fuel tank is carried by the frame at a low position and forward of the power unit. Fourth, the rider's seat and footrests are placed so that the rider centers his weight between the front and rear tires. Finally, to improve handling, the wheel base (the distance between the front and rear axeles) is equal to the track base (the distance between the center of the front wheels). While this vehicle may be acceptable for off-road use, it is not designed for road use and does not possess the performance characteristics needed for a road vehicle. Additionally, it is not designed with operator comfort in mind.

At least one other vehicle is known in the prior art that includes a pair of front wheels and a single rear wheel. This vehicle is a snowmobile that has been adapted for non-snow use. In this vehicle, the skis at the front of the vehicle are replaced with wheels and the endless track beneath the seat is replaced with a single rear tire.

While there are many examples of three-wheeled vehicles in the prior art, none have been designed for operator comfort, stability, and performance in mind.

Specifically, three-wheeled vehicles that are modified from motorcycles or snowmobiles typically have relatively high centers of gravity, which decrease their operational stability. Moreover, being adaptations from motorcycles and snowmobiles, operational and ergonomic characteristics are less than optimal.

As a result, a need has developed for a high-performance three-wheeled vehicle. In particular, a desire has developed for a three-wheeled vehicle that provides operator comfort, is ergonomically designed, and is capable of road use.

### SUMMARY OF THE INVENTION

One aspect of this invention, therefore, is to provide a three-wheeled vehicle having two wheels supported at the front of the vehicle and one wheel supported at the rear of the vehicle.

An additional aspect of this invention is to provide a three-wheeled vehicle with a pair of steerable front wheels and a single driven rear wheel.

Another aspect of this invention is to provide a three-wheeled vehicle with a straddle-type seat that can accommodate one or more riders.

A further aspect of this invention is to provide a three-wheeled vehicle that is specifically designed to accommodate a rider comfortably while riding.

An aspect of this invention is to design a three-wheeled vehicle with a low center of gravity and a stable wheel configuration to improve maneuverability and control and, therefore, assist in ease of operation.

Accordingly, the present invention is directed to a three-wheeled vehicle for road use, comprising a frame having a front portion, a rear portion, and a longitudinal centerline with a pair of front wheels supported at the front of the frame on either side of the longitudinal centerline and a single rear wheel supported at the rear of the frame. A power source is supported by the frame between the front wheels and the rear wheel and operatively coupled to one of the wheels for driving the wheel. A seat is supported by the frame. The seat defines a seat reference point. A footrest extends outwardly from the frame at a position below the seat. A handlebar is supported by the frame and is operatively coupled to the front wheels for turning the front wheels. The handlebar is disposed a first longitudinal distance from the footrest and is disposed a second longitudinal distance from the seat reference point.

The three-wheeled vehicle according to this invention also comprises a frame having a front portion, a rear portion, and a longitudinal centerline, with a pair of front wheels supported at the front of the frame on either side of the longitudinal centerline and a single rear wheel supported at the rear of the frame. A power source is supported by the frame between the front wheels and the rear wheel and operatively coupled to one of the wheels for driving the wheel. A seat is supported by the frame. The seat defines a seat reference point. A footrest extends outwardly from the frame at a position below the seat. A handlebar is supported by the frame and operatively coupled to the front wheels for turning the front wheels. The handlebar is disposed a first vertical distance from the ground, the seat reference point is disposed a second vertical distance from the ground, and the footrest is disposed a third distance from the ground.

The three-wheeled vehicle of this invention also includes a seat that has a passenger portion. The passenger seat portion defines a passenger seat reference point. The handlebar is disposed a third longitudinal distance from the passenger seat reference point. The handlebar is also disposed a third vertical distance from the passenger seat reference point.

A three-wheeled vehicle according to this invention further comprises a frame having a front portion, a rear portion, and a longitudinal centerline. The vehicle includes a pair of front wheels supported at the front of the frame on either side of the longitudinal centerline and a single rear wheel supported at the rear of the frame. A power source is supported by the frame between the front wheels and the rear wheel and is operatively coupled to one of the wheels for driving the wheel. A seat is supported by the frame. The seat defines a seat reference point. A footrest extends outwardly from the frame at a position below the seat. A handlebar is supported by the frame and is operatively coupled to the front wheels for turning the front wheels. An angle between the seat reference point and the footrest measured from the handlebar is within a predetermined range. An angle between the handlebar and the footrest measured from the seat reference point is within a predetermined range.

Other objects, aspects and features of the invention will be apparent in view of the following description and drawings.

### BRIEF DESCRIPTION OF THE DRAWINGS

Referring to the drawings that form a part of the original disclosure:

FIG. 1 is a front view of the three-wheeled straddle-type vehicle in accordance with a preferred embodiment of the invention;

FIG. 2 is a right side view of the three-wheeled vehicle of FIG. 1;

FIG. 3 is a top view of the three-wheeled vehicle of FIG. 1;

FIG. 4 is a schematic top view of the three-wheeled vehicle of FIG. 1, showing the possible positioning of four differently-sized riders thereon;

FIG. 5 is a schematic side view of the three-wheeled vehicle of FIG. 1, illustrating the possible positioning of four differently-sized riders thereon;

FIG. 6 is a schematic front view of the three-wheeled vehicle of FIG. 1, depicting the possible positioning of four differently-sized riders thereon;

FIG. 7 is diagram showing certain reference points on the three-wheeled vehicle of the invention as depicted in FIGS. 4-6; and

FIG. 8 is a diagram showing a parameters for three different sizes of the typical North American male, the dimensions of which are relied upon in determining the size and shape of the various elements comprising the three-wheeled vehicle of FIGS. 1-3.

### DETAILED DESCRIPTION OF PREFERRED EMBODIMENTS OF THE INVENTION

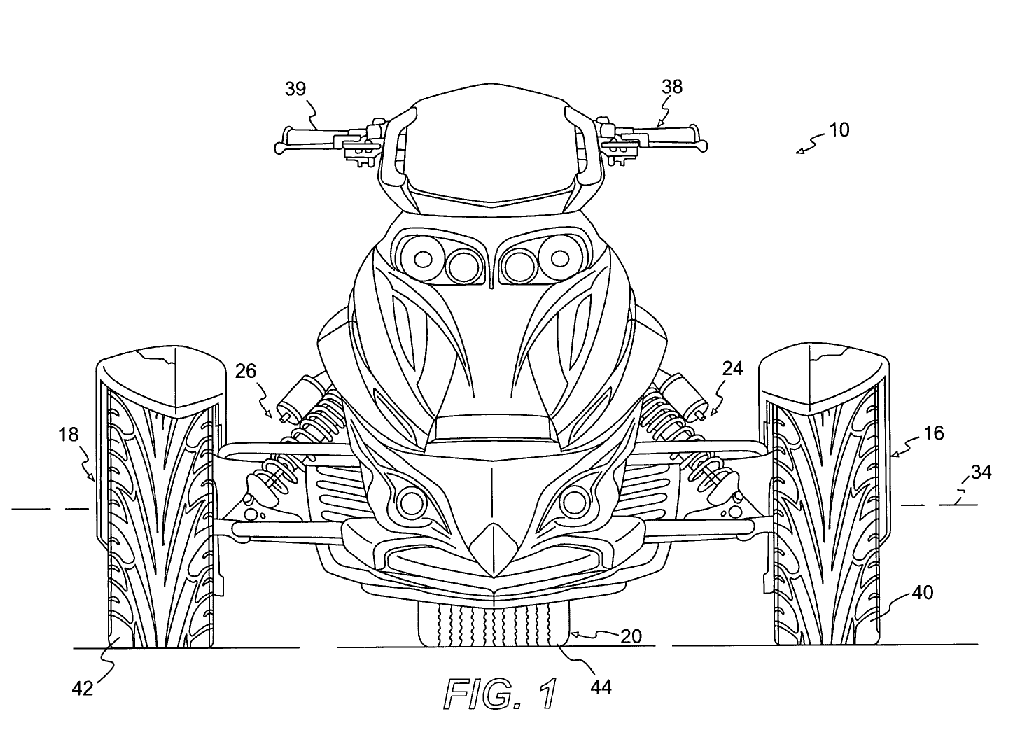

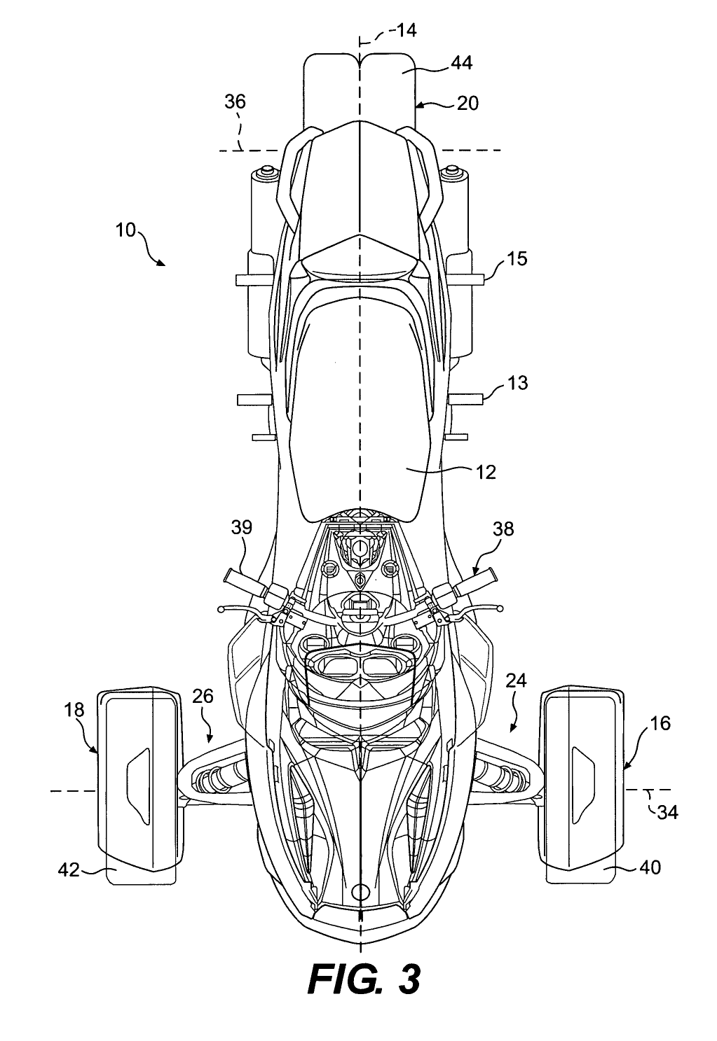

A three-wheel straddle-type vehicle 10 in accordance with a preferred embodiment the present invention is generally illustrated in FIGS. 1-3. The vehicle 10 is provided with a straddle-type seat assembly 12 that preferably accommodates at least one adult-sized rider. It is also contemplated that the seat assembly 12 could accommodate a driver and a passenger or a driver and multiple passengers.

It should be noted that the conventions “left,” “right,” “front,” “rear,” “up,” and “down” are defined according to the normal, forward travel direction of the vehicle. As a result, the “left” side of a vehicle corresponds to the left side of a rider seated in a forward-facing position on the vehicle.

Before delving into the specific details of the vehicle 10, it is noted that the straddle-type seat assembly 12 is a seat assembly specific to certain vehicles including motorcycles, snowmobiles, ATVs, and personal watercraft (“PWCs”), among others. In particular, as may be appreciated from the illustrations of the vehicle 10, a straddle-type seat (which is also known as a “straddle seat”) is one where the legs of the operator and any passengers are disposed on either side thereof. The operator and passenger straddle the seat, hence, the name of the seat.

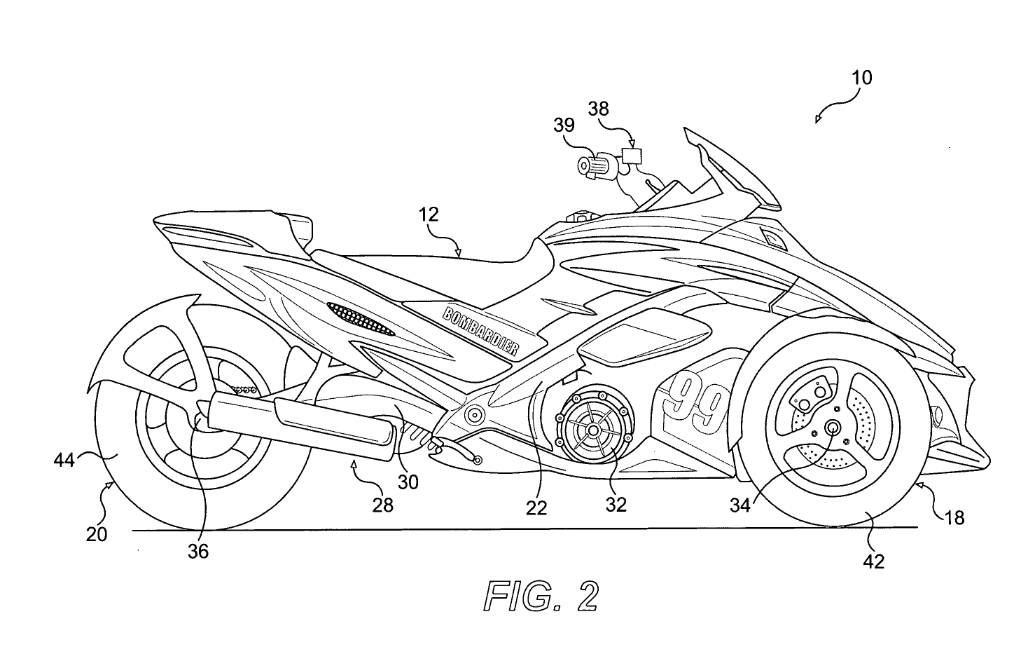

Referring to FIGS. 1-3, the vehicle 10 is designed along a longitudinal axis 14. It includes a left front wheel 16, a right front wheel 18 and a rear wheel 20, each of which are mounted on the main frame 22 (a portion of which is shown in FIG. 2). The main frame 22 is preferably tubular and provides a rigid support that can withstand forces generated when the vehicle 10 is operating at high speeds. The seat 12 is mounted on the frame 22. Driver footrests 13 and passenger footrests 15 extend outwardly from the frame 22 below the seat 12. The footrests 13 and 15 could be footpegs or foot boards or any structure suitable for resting a person's foot.

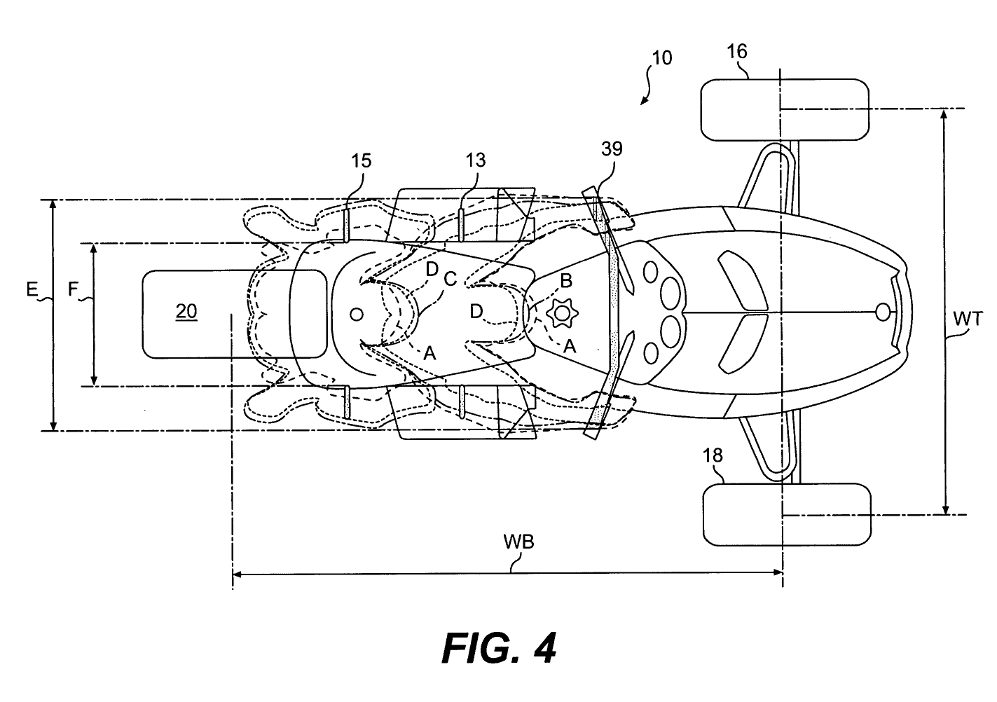

The main frame 22 supports the front wheels 16, 18 by suspension assemblies 24, 26, respectively, extending from each side of the vehicle 10. Each front wheel 16, 18 is mounted to rotate about a horizontal axis of rotation 34 and is disposed a predetermined lateral distance from the longitudinal axis 14. The distance between the center points of the two front wheels is called the wheel track WT, which is shown in FIG. 4. The rear wheel 20 is supported by a rear suspension assembly 28 including a swing arm 30, shown partially in FIG. 2. The rear wheel 20 is mounted to rotate about a horizontal axis of rotation 36, which is a predetermined distance from the front wheel axis 34. The distance between the axes 34 and 36 is called the wheel base WB, which is shown in FIG. 4.

An engine 32 is mounted within the frame 22, generally along the longitudinal axis 14 and at a horizontal level generally corresponding to the height of the front wheel axis 34 and the rear wheel axis 36. The engine 32 is operatively connected to the rear wheel 20 to impart a driving force thereto. The engine 32 can be connected to the rear wheel 20 by a geared assembly or by a transmission, such as a continuously variable transmission. Preferably, the engine is a four stroke, internal combustion engine, although any other suitable power source may be substituted therefor.

A steering mechanism or assembly 38 is supported by the frame 22 in front of the straddle-type seat 12 and is operatively connected to the front wheels 16 and 18 for steering. Turning the steering assembly 38 turns the front wheels 16 and 18 in correspondence. The steering assembly 38 preferably includes handlebars 39, but could be any known type of steering mechanism including a steering wheel or other known device. The steering assembly 38 may be adjustable and may include a progressive steering system.

The three-wheeled vehicle 10 in accordance with preferred embodiments of this invention may include other components normally associated with a road vehicle, which would be understood by those of ordinary skill in the art and need not be described in further detail. For example, the vehicle 10 will include such elements as rear-view mirrors, turning signals, headlamps, and brake lights, all of which are required by most national and local motor vehicle administrations for road-use vehicles.

The front wheels 16, 18 and rear wheel 20 are each equipped with tires 40, 42, 44, respectively, preferably suitable for road use. Preferably, the tires 40, 42, 44 are the same size, i.e. have the same diameter. One example of a preferred tire size diameter is 15 inches (about 38 cm). However, it is within the scope of this invention to use different size tires on the front and the rear of the vehicle 10. The rear tire 44 is preferably wider than the front tires 40, 42, as seen in FIG. 1. Any type of commercially available road tire, especially an automobile tire, can be used. For example, one type of tire suitable for the front wheels 16, 18 of this vehicle 10 is a Toyo Proxes 195/45R15 78V T-1S. The rear wheel 20 may also include multiple rims, with each rim accommodating a tire. In the case of a multi-rim arrangement, the rims would be rigidly connected to form a single wheel. For purposes of simplicity, when the rear tire is referred to in this application, it will be understood that the rear tire may include multiple tire components mounted on individual rims but acting as a single wheel.

The three-wheeled vehicle in accordance with preferred embodiments of this invention is designed with parameters chosen to increase its stability and to conform to human ergonomics so as to enhance rider comfort. The inventors of the vehicle 10 discovered that it is desirable to optimize various dimensional and angular relationships to provide a vehicle that is comfortable to variously sized riders.

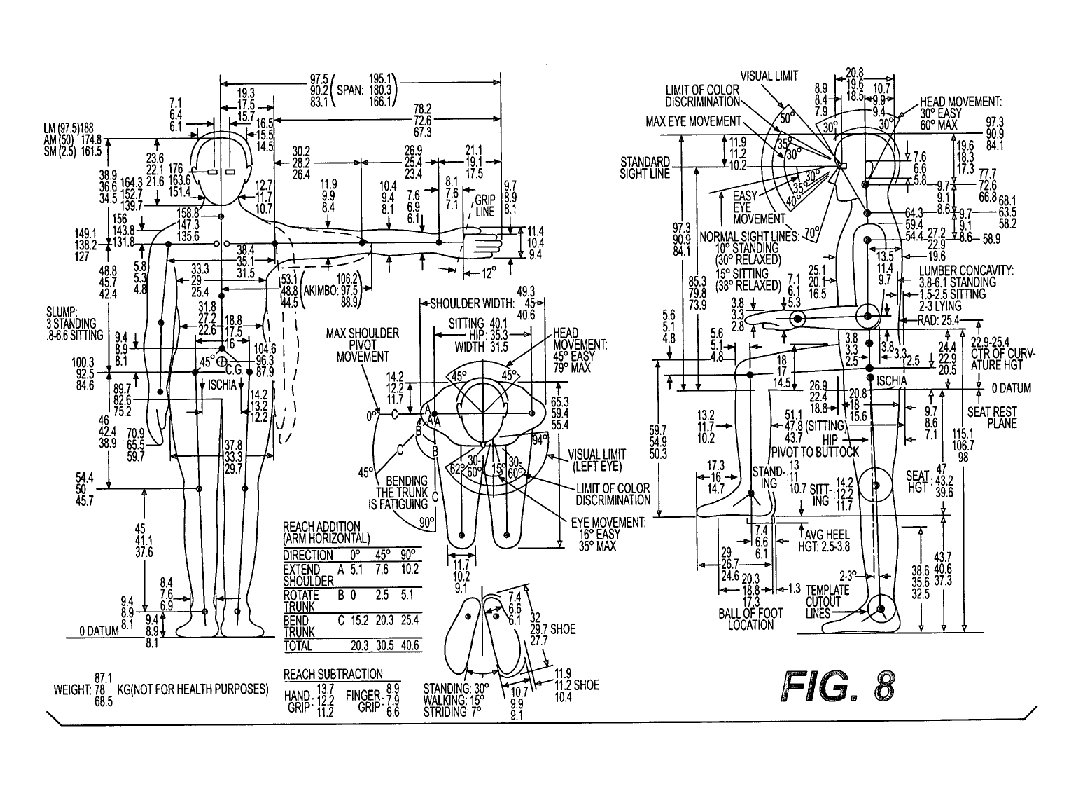

As shown in FIG. 8, for purposes of illustration, a standard rider can be assumed to be a 50^{th} percentile North American male who weighs about 78 kilograms (kg) (about 174.8 lbs.) and is about 174.7 cm tall. Precise dimensions of such a rider are explained in U.S. application Ser. No. 60/167,614 filed Nov. 26, 1999 and U.S. application Ser. No. 09/472,134 filed Dec. 23, 1999, both disclosures of which are incorporated by reference herein. The rider can be considered to be a simple live load for the calculation. For example, a test dummy weighing about 180 pounds could be used.

FIG. 8 provides certain dimensional parameters for three different body types, for a small male (SM) (2.5% of the population average size), an average male (AM) (50% of the population average size), and a large male (LM) (97.5% of the population average size). When designing the vehicle 10, the inventors used the dimensions of the average male as a calculational tool to optimize several of the dimensional characteristics described in greater detail below.

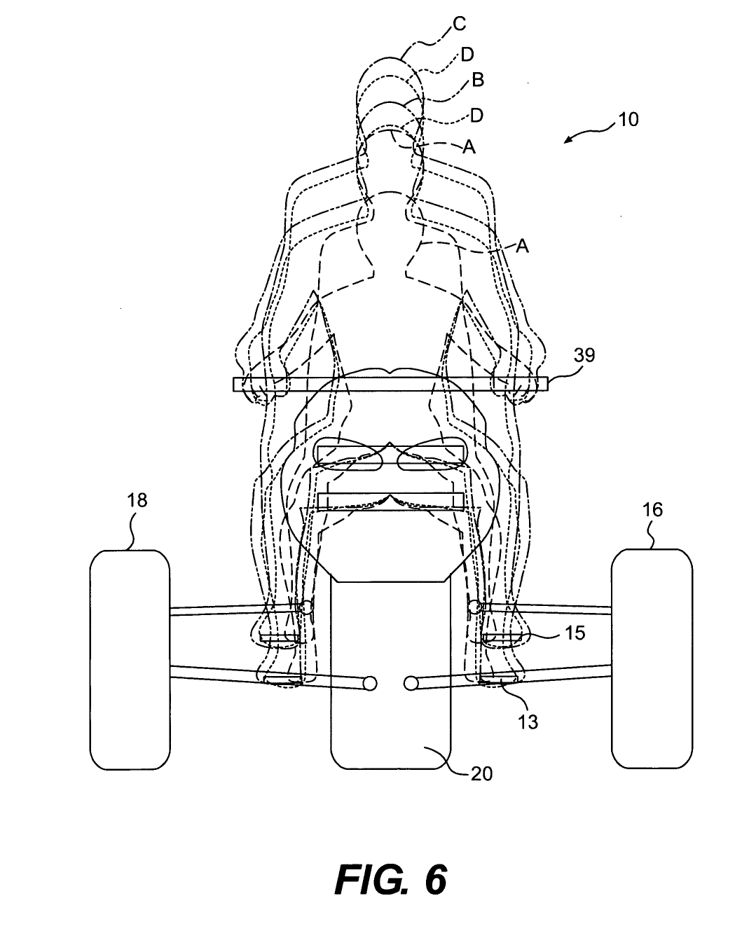

The exemplary riders shown in FIGS. 4-7 include a 5 percentile female rider (represented by the smallest rider outline A), a 95 percentile male rider positioned in the driver's seat (represented by the largest driver outline B), a 95 percentile male rider positioned in the passenger's seat (represented by the largest passenger outline C); and a 50 percentile male rider (represented by the intermediate driver and passenger outline D).

An example of specific dimensions and values for a vehicle 10, designed in accordance with a preferred embodiment of this invention, is as follows. Referring to FIG. 4, the wheelbase WB is about 68 inches (in.) (1727 mm), and preferably within a range of between about 47 in. (1194 mm) and 138 in. (3505 mm). The wheel track WT is about 51.5 in. (1308 mm), and preferably within a range of between about 40 in. (1016 mm) and 87 in. (2210 mm). The overall width E of the vehicle 10, exclusive of the front wheels, measured from the outermost point of each handlebar 39 is about 27.5 in. (699 mm), and preferably within a range of between about 16 in. (406 mm) and 38 in. (965 mm). The width F of the body of the vehicle 10, measured between the point of connection of opposed footrests 13 and 15 to the frame is about 17.5 in. (445 mm), and preferably within a range of between about 12 in. (305 mm) and 30 in. (762 mm).

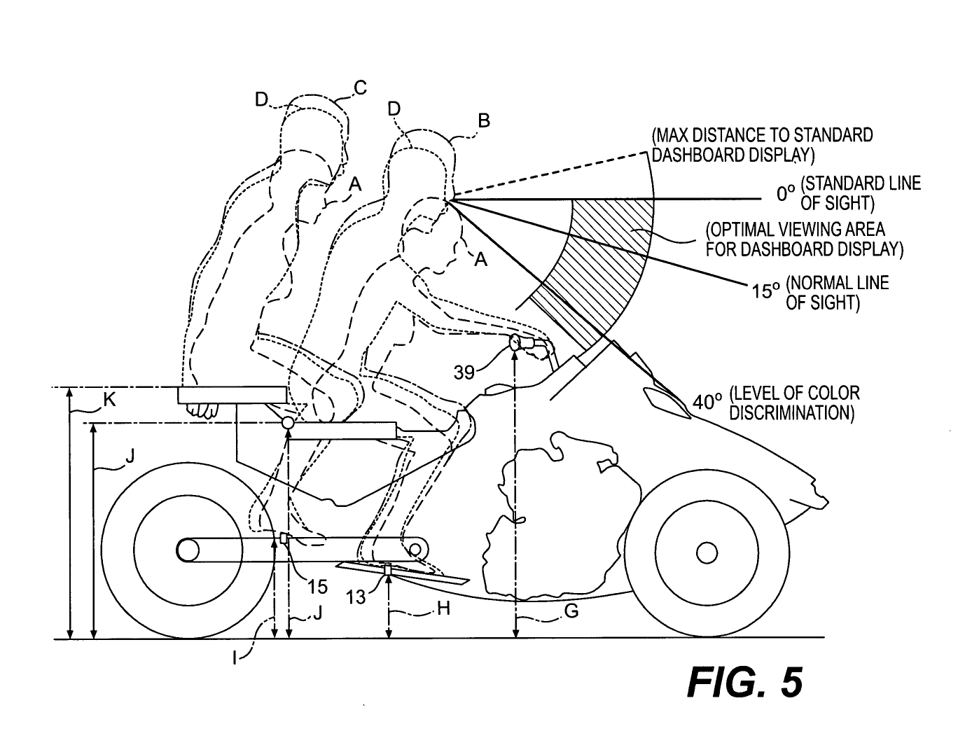

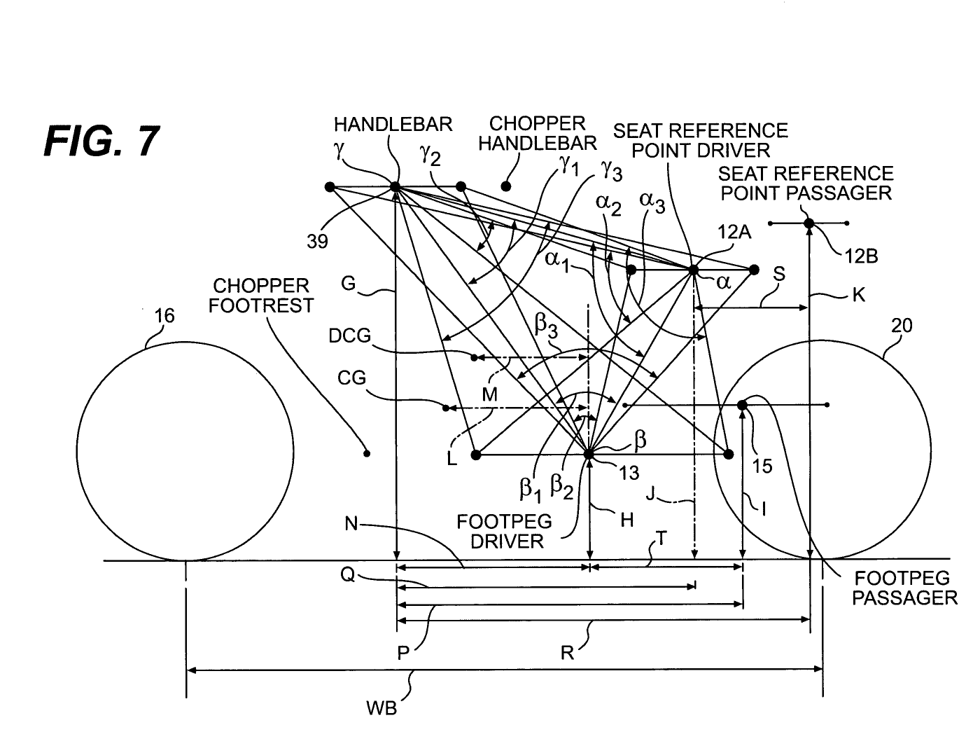

In FIGS. 5 and 7, preferred heights of various components are shown. Each preferred height has a preferred range in which the dimension fall. The height G of the handlebars 39 is preferably in the range of about 29 in. (737 mm) to 46.5 in. (1181 mm) from the ground, with about 37 in. (940 mm) being the most preferred. The height H of the driver footrest 13 above the ground is in the range of about 5 in. (127 mm) to about 18 in. (457 mm), with 10 in. (254 mm) being most preferred. In the case of a touring style seat, the preferred height of the driver floorboard would be about 7.5 in. (191 mm). The height I of the passenger footrest 15 from the ground is in the range of about 5 in. (127 mm) to 22 in. (559 mm), with about 14 in. (356 mm) being most preferred. In the case of a touring style seat, the preferred height of the passenger floorboard would be about 12.25 in. (311 mm). The height J of the driver seat reference point is in the range of about 20 in. (508 mm) to 36 in. (914 mm), with about 28 in. (711 mm) being most preferred. The height K of the passenger seat reference point is in the range of about 20 in. (508 mm) to 40 in. (1016 mm), with about 32 in. (813 mm) being most preferred.

The components have the following preferred widths measured between outermost points. The steering mechanism, which is preferably a handlebar, has a width in the range of about 24 in. (609 mm) to 35 in. (889 mm), with about 30 in. (762 mm) being most preferred. The driver or forward seat preferably has a width in the range of about 11 in. (279 mm) to about 20 in. (508 mm), with 16 in. (406 mm) being most preferred. The aft seat or passenger seat preferably has a width in the range of about 9 in. (228 mm) to about 16 in. (406 mm), with about 11 in. (279 mm) being most preferred. The forward or drive footrest has a width between footrests in the range of about 30 in. (762 mm) to 40 in. (1016 mm), with about 35 in. (889 mm) most preferred. The aft or passenger footrest has a width between footrests in a range of about 25 in. (635 mm) to 35 in. (889 mm), with about 29.5 in. (749 mm) being most preferred.

FIG. 7 shows various dimensional relationships developed with ergonomic considerations according to the three-wheeled vehicle 10 according to a preferred embodiment of this invention. FIG. 7 locates the center of gravity CG of the vehicle 10 and the center of gravity of the vehicle 10 with a standard rider DCG. A typical rider's CG is about 7-8 inches (178-203 mm) above the vehicle seat 12. Accordingly, the DCG of the vehicle 10 with the rider is above the position of the height of the CG for the vehicle 10 alone, as shown in FIG. 7. The center of gravity CG is calculated using known techniques for determining the location of the CG including the dimensions and mass distribution of the object.

The CG for this vehicle 10 is shown in FIG. 7 at a representative position for purposes of illustration. It is not intended to be a limiting location and obviously would change based on changes in the vehicle weight and dimensions. Preferably, the horizontal distance L from the vehicle CG to the footrest 13 of the driver is about 18 in. (457 mm), and more preferably within a range of between about 6 in. (152 mm) and 28 in. (711 mm) The horizontal distance M from the center of gravity of the vehicle 10 and the driver DCG to the footrest 13 of the driver is about 14 in. (356 mm), and preferably within a range of between about 0.5 in. (127 mm) and 27.5 in. (699 mm).

The preferred distances between elements measured in a longitudinal direction parallel with a horizontal reference line are as follows.

Starting at the handlebar 39, the distance N to the driver footrest 13 is about 18 in. (457 mm), with a minimum preferred distance of about 8 in. (203 mm) and a maximum preferred distance of about 27 in. (686 mm). The distance P from the handlebar 39 to the passenger footrest 15 is about 29.5 in. (749 mm), with a minimum preferred distance of about 18.5 in. (470 mm) and a maximum preferred distance of about 43 in. (1092 mm).

The distance Q from the handlebar 39 to the driver seat reference point 12A is about 28 in. (711 mm), with a minimum preferred distance of about 20 in. (508 mm) and a maximum preferred distance of about 36 in. (914 mm). The distance R from the handlebar 39 to the passenger seat reference point 12B is about 42 in. (1067 mm), with a minimum preferred distance of about 32 in. (813 mm) and a maximum preferred distance of about 52 in. (1321 mm).

Now, referring to the seat 12, the distance S from the driver seat reference point 12A to the passenger seat reference point 12B is about 12 in. (305 mm), with a minimum preferred distance of about 6 in. (152 mm) and a maximum preferred distance of about 23 in. (584 mm). With respect to the footrests 13 and 15, the distance T is about 12 in. (305 mm), with a minimum preferred distance of about 6 in. (152 mm) and a maximum preferred distance of about 24 in. (610 mm).

The preferred angular relationships between the handlebar 39, the driver's footrest 13, the passenger footrest 15 and the driver's seat 12A reference point is as follows. From driver's seat reference point 12A, an angle drawn between the outermost point of the handlebar 39 to the driver's footrest 13 is α₁, which is about 74°. The minimum desired angle α₂ is about 45°, and the maximum angle α₃ is about 100°. From the driver's footrest 13, an angle drawn between the driver's seat reference point 12A and the handlebar 39 is β₁, which is about 65°. The minimum desired angle β₂ is about 40°, and the maximum angle β₃ is about 85°. From the handlebar 39, an angle drawn from the driver's seat reference point 12A to the driver's footrest 13 is γ₁, which is about 41°. The minimum desired angle γ₂ is about 21°, and the maximum angle γ₃ is about 80°.

The seat 12 arrangement shown in FIG. 7 shows a two rider configuration in which the passenger portion of the seat 12 is raised with respect to the driver portion of the seat 12. The seat 12 and hence the vehicle 10 may be designed within the parameters disclosed herein for a single rider, with only a driver portion of the seat 12. Additionally, the passenger portion of the seat 12, if provided, may be on the same level as the driver portion.

FIG. 7 also shows an alternate handlebar and footrest configuration for a “chopper” style vehicle in which the driver rides in a slightly rearwardly inclined position.

Given these preferred ranges of dimensions and angular relationships, riders of various sizes can have an optimal range of sight when riding on the three-wheeled vehicle 10, as shown in FIG. 5. As shown, a 50 percentile male driver D has an optimal viewing zone, shown shaded, in which the standard line of sight is 0° from horizontal, the normal line of sight is 15° from horizontal and the limit of color discrimination in 40° from horizontal.

All of the above noted dimensions are provided for purposes of description and are not intended to be limiting of the invention. The drawings are not necessarily drawn to scale. The various parameters could, of course, be varied and remain within the scope of the invention. Further, the size of the various components that may appear in the drawings can vary from the size shown.

The embodiments described herein are intended to be illustrative of this invention. As will be recognized by those of ordinary skill in the art, various modifications, combination of features, equivalent arrangements and changes can be made and would remain within the scope of the invention defined in the appended claims.

What is claimed is:

1. A three-wheeled vehicle for road use, comprising:
a frame having a front portion, a rear portion, and a longitudinal centerline;
a pair of front wheels supported at the front of the frame on either side of the longitudinal centerline, each of the front wheels having tires mounted thereon suitable for road use;
a single rear wheel supported at the rear of the frame, the rear wheel having at least one tire mounted thereon suitable for road use;
a power source supported by the frame between the front wheels and the rear wheel and operatively coupled to one of the wheels for driving the wheel;
a seat supported by the frame defining a seat reference point;
a footrest extending outwardly from the frame at a position below the seat reference point; and
a steering mechanism supported by the frame and operatively coupled to the front wheels for turning the front wheels,
wherein the steering mechanism is disposed a first longitudinal distance from the footrest and is disposed a second longitudinal distance from the seat reference point.

2. The vehicle of claim 1, wherein the first longitudinal distance is between about 51 mm and 1092 mm.

3. The vehicle of claim 2, wherein the first longitudinal distance is about 533 mm.

4. The vehicle of claim 1, wherein the second longitudinal distance is between about 470 mm to 1143 mm.

5. The vehicle of claim 4, wherein the second longitudinal distance is about 813 mm.

6. The vehicle of claim 1, wherein the seat includes a driver seat portion and a passenger seat portion, wherein the passenger seat portion has a passenger seat reference point.

7. The vehicle of claim 1, wherein the steering mechanism is disposed a third longitudinal distance from the passenger seat reference point.

8. The vehicle of claim 7, wherein the third longitudinal distance is between about 686 mm to 1410 mm.

9. The vehicle of claim 8, wherein the third longitudinal distance is about 965 mm.

10. A three-wheeled vehicle for road use, comprising:
a frame having a front portion, a rear portion, and a longitudinal centerline;
a pair of front wheels supported at the front of the frame on either side of the longitudinal centerline having a tire suitable for road use mounted on each front wheel;
a single rear wheel supported at the rear of the frame having at least one tire suitable for road use mounted on the rear wheel;
a power source supported by the frame between the front wheels and the rear wheel and operatively coupled to one of the wheels for driving the wheel;
a seat supported by the frame defining a seat reference point;
a footrest extending outwardly from the frame at a position below the seat reference point; and
a steering mechanism supported by the frame and operatively coupled to the front wheels for turning the front wheels,
wherein the steering mechanism is disposed a first vertical distance from the ground, the seat reference point is disposed a second vertical distance from the ground, and the footrest is disposed a third vertical distance from the ground.

11. The vehicle of claim 10, wherein the seat includes a driver seat portion and a passenger seat portion, wherein the passenger seat portion has a passenger seat reference point.

12. The vehicle of claim 10, wherein the first vertical distance is between about 686 mm to 1143 mm.

13. The vehicle of claim 12, wherein the first vertical distance is about 990 mm.

14. The vehicle of claim 10, wherein the second vertical distance is between about 457 mm to 927 mm.

15. The vehicle of claim 14, wherein the second vertical distance is about 775 mm.

16. The vehicle of claim 10, wherein the third vertical distance is between about 152 mm to 483 mm.

17. The vehicle of claim 16, wherein the third vertical distance is about 279 mm.

18. A three-wheeled vehicle for road use, comprising:
a frame having a front portion, a rear portion, and a longitudinal centerline;
a pair of front wheels supported at the front of the frame on either side of the longitudinal centerline;
a tire suitable for road use mounted on each front wheel;
a single rear wheel supported at the rear of the frame;
at least one tire suitable for road use mounted on the rear wheel;
a power source supported by the frame between the front wheels and the rear wheel and operatively coupled to one of the wheels for driving the wheel;
a seat supported by the frame defining a seat reference point;
a footrest extending outwardly from the frame at a position below the seat; and
a steering mechanism supported by the frame and operatively coupled to the front wheels for turning the front wheels,
wherein an angle between the seat reference point and the footrest measured from the handlebar is within a predetermined range.

19. The vehicle of claim 18, wherein the angle is between about 52.59 degrees to 120.37 degrees.

20. The vehicle of claim 19, wherein the angle is about 75.5 degrees.

21. A three-wheeled vehicle for road use, comprising:
a frame having a front portion, a rear portion, and a longitudinal centerline;
a pair of front wheels supported at the front of the frame on either side of the longitudinal centerline;
a tire suitable for road use mounted on each front wheel;
a single rear wheel supported at the rear of the frame;
at least one tire suitable for road use mounted on the rear wheel;
a power source supported by the frame between the front wheels and the rear wheel and operatively coupled to one of the wheels for driving the wheel;
a seat supported by the frame defining a seat reference point;
a footrest extending outwardly from the frame at a position below the seat; and
a steering mechanism supported by the frame and operatively coupled to the front wheels for turning the front wheels,
wherein an angle between the handlebar and the footrest measured from the seat reference point is within a predetermined range.

22. The vehicle of claim 21, wherein the angle is between about 39.56 degrees to 86.08 degrees.

23. The vehicle of claim 21, wherein the angle is about 66.30 degrees.
